(19) United States
(12) Patent Application Publication
(10) Pub. No.: US 2006/0290765 A1
(43) Pub. Date: Dec. 28, 2006

(54) Image-forming element

(75) Inventors: Catharinus Van Acquoij, Venray (NL); Norbert H.W. Lamers, Reuver (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/473,038

(22) Filed: Jun. 23, 2006

(30) Foreign Application Priority Data
Jun. 27, 2005 (EP) 05105712.3

(51) Int. Cl. B41J 2/385; G01D 15/06

(52) U.S. Cl. 347/111

(57) ABSTRACT

An image-forming element including a hollow drum body rotatable about an axis and having an outer wall surface, a plurality of circumferentially extending electrodes supported on an electrically insulating layer arranged on the outer wall surface of the drum body, an electronic control unit containing a drivers circuit for energizing the electrodes, a support structure for supporting the drivers circuit, and contact means for electrically connecting each of the electrodes individually to the electronic control unit. The electronic control unit is arranged on the outer wall surface of the drum body. A recess for accommodating the drivers circuit may be provided in the outer wall surface of the drum body.

Applicants hereby claim priority under 35 U.S.C. 119 based on European Patent Application No. 05105712.3 filed in Europe on Jun. 27, 2005.

### BACKGROUND OF THE INVENTION

The present invention relates to an image-forming element including a hollow drum body rotatable about an axis and having an outer wall surface, a, plurality of circumferentially extending electrodes supported on an electrically insulating layer arranged on the outer wall surface of the drum body, an electronic control unit containing a drivers circuit for energizing the electrodes, a support structure for supporting the drivers circuit, and contact means for electrically connecting each of the electrodes individually to the electronic control unit.

Image-forming elements are known from EP 0803 783 A1. In the known image-forming elements, the electronic control unit comprises a printed circuit board on which driver circuitry is mounted and which carries a pattern of electrical conductors which lead to a terminal array. The electronic control unit is shaped as an elongate body and is mounted inside a hollow drum body such that the terminal array formed at a longitudinal edge of the elongate body adjoins the internal wall surface of the drum body. Each of the conductors which lead to the terminal array is electrically connected to a corresponding one of the electrodes by contact means which pass through the wall of the hollow drum body.

A problem of the known drum body is the complicated manufacturing thereof. Through-holes have to be formed through the wall of the drum body, and have to be filled in with conductive material in order to provide contact of the electronic control unit with the electrodes placed on the outer surface of the drum body. The present invention seeks to provide an image-forming element for a printing apparatus in which the complications of the prior art are mitigated.

### SUMMARY OF THE INVENTION

In accordance with the present invention, this object is accomplished in an image-forming element of the above mentioned kind, wherein the electronic control unit is arranged on the outer wall surface of the drum body. The manufacturing of the image-forming element is simplified and the production costs are thus reduced compared to the known image-forming elements. In particular, connecting the electrodes to the drivers circuitry can be realized in a much more simple and direct way.

According to an embodiment of the present invention, a recess for accommodating the drivers circuitry is formed in the outer wall surface of the drum body, the drivers circuitry being fixed in the recess. In this embodiment, the drivers circuitry is advantageously well protected from negative external influences such as temperature changes and high mechanical pressures during printing.

According to another embodiment of the present invention, the contact means includes a number of electrically-conducting projections extending upwardly from the drivers circuitry and having a dimension in a direction substantially parallel to the axis of the drum body of at least twice the pitch of the electrodes. The advantage of this embodiment is that the positioning of the electrodes with respect to the electronic control unit does not have to be realized with a very high degree of precision.

### BRIEF DESCRIPTION OF THE DRAWINGS

The present invention will now be explained with reference to the following exemplified embodiments of the present invention, and illustrated by reference to the drawings. The present embodiments serve to illustrate the present invention and should not be regarded as a limitation of the scope thereof.

FIG. 1 is a schematic diagram of a printing apparatus using direct induction printing technique.

FIG. 2 is a schematic diagram of an image-forming element according to an embodiment of the invention.

FIG. 3A is a schematic diagram of an image-forming element according to a first embodiment of the invention (cross section along a line YY).

FIG. 3B is a schematic diagram of an image-forming element according to a second embodiment of the invention (cross section along a line YY).

FIG. 4 is a schematic diagram of an image-forming element according to an embodiment of the invention (cross section along a line XX).

FIG. 5 is a schematic diagram of an image-forming element according to an embodiment of the invention (top view).

FIG. 6 is a schematic diagram of an image-forming element according to another embodiment of the invention.

FIGS. 7A (top view), 7B (cross section), 7C (top view) and 7D (cross section) are schematic diagrams of an image-forming element according to an embodiment of the invention.

### DETAILED DESCRIPTION OF THE DRAWINGS

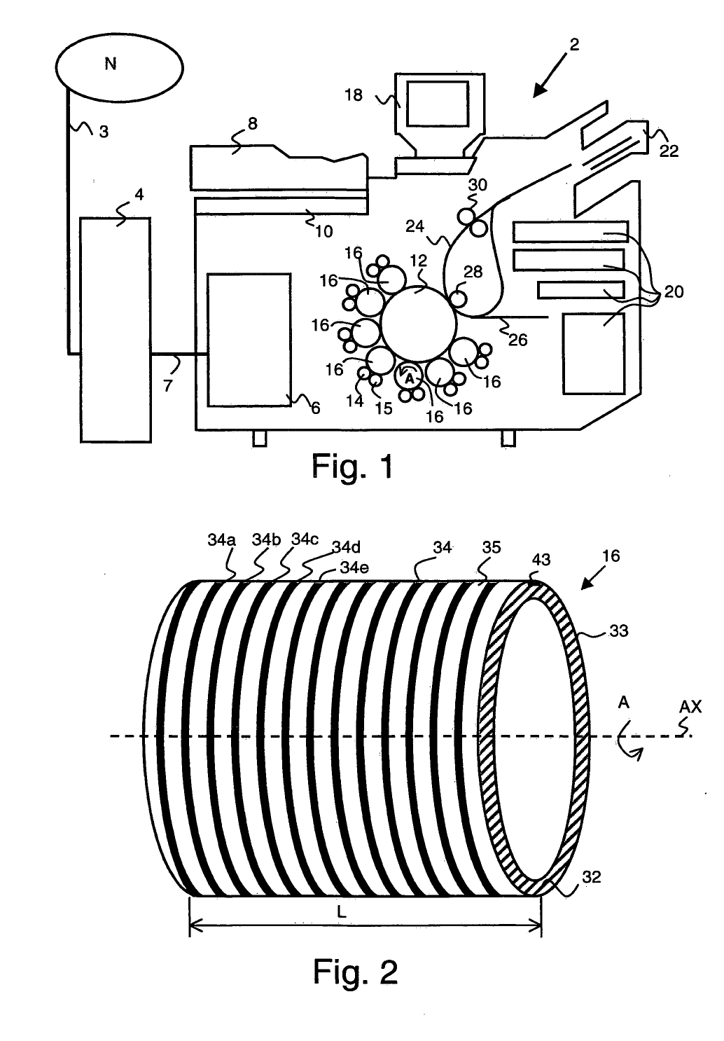

FIG. 1 is a schematic diagram of a printing apparatus using the direct induction printing technique. The printing apparatus includes a print engine 2 which is connected to a print server 4 suited for sending print jobs to the print engine 2 through a connection cable 7. The print server 4 is further connected to a network N, the connection being diagrammatically shown in the form of a cable 3. N may be a local area network that enables a number of users with logged on client computers to send print jobs to the printer 2, or may represent the internet. The print server 4 receives print jobs from the client computers, converts them in a format that can be processed by the print engine 2 and ensures, in co-operation with an image processing unit 6 placed inside the print engine 2, that the digital images sent with the print jobs are printed on image supports.

The printing apparatus is provided with an automatic document feeder 8 for automatically feeding to a scanner unit 10 an original sheet or a stack of original sheets placed in the feeder. The scanner unit 10 is suited for optically scanning an original sheet fed thereto and for converting the optical information into electrical image signals by means of photoelectric sensors such as CCDs.

The printing apparatus also comprises a user interface panel 18, provided with a display screen and a key panel. The user interface panel is connected to the image processing unit 6 and to the print server 4 and is suited for selecting a user, setting queuing parameters, changing job attributes etc.

The print engine includes a number of image-forming elements 16. Each image-forming element comprises a rotating drum which can be driven in the direction of the arrow A by suitable driver means (not shown). For printing color images, a plurality of image-forming elements is used, each of said elements being supplied with toner in a specific color like cyan, magenta, yellow, red, blue, green or black for forming a separation image. Each image-forming element 16 is provided with a number of energizable image-forming electrodes placed beneath a dielectric layer. The electrodes are placed at a given distance from each other which determines the axial resolution of the print system, for example 600 dpi. A magnetic roll 14 and a developing unit 15 are provided. Conductive and magnetically attractive toner powder is supplied to the magnetic roll 14. By applying a predefined bias voltage to the magnetic roll 14, a uniform layer of toner powder is applied to the outer surface of the image-forming element 16. A soft-iron knife is disposed inside of the developing unit 15 and is placed between two magnets for generating a magnetic field in a gap. In order to develop a toner image on the image-forming element 16, the electrodes placed on the outer circumferential surface of the drum are activated image-wise by means of an electronic control unit having a drivers circuitry for energizing the electrodes individually. In an image-forming zone defined by the magnetic field in the gap, the toner powder is selectively removed from the surface of the image-forming element 16, depending on the activation pattern on the ring electrodes.

A toner powder image, being a separation image, is thus formed on the surface of each image-forming element 16. Each separation image is then transferred successively by means of pressure contact with an image receiving medium, for example a transfer drum 12 having a rubber surface. The complete color image is thus formed on said rubber surface and can be transferred and fused onto a print medium (for example a sheet of paper) by a suitable combination of pressure and temperature. The sheet of paper is conveyed from any of the paper trays 20 to the transfer drum by the guide track 26 and is then pressed between the heated transfer drum 12 and the pressure roll 28. The sheet of paper is then conveyed by the guide track 24 to the post fuser unit 30 and can undergo a duplex loop for printing on the reverse side, or can be directly output to the receiving tray 22.

An image-forming element 16 according to an embodiment of the present invention is shown in FIG. 2. The image-forming element 16 comprises a hollow drum body 32 which is rotatable about an axis AX and has an outer wall surface 33. The image-forming element 16 is provided with a plurality of circumferentially extending electrodes 34 (for example 34a, 34b, 34c, 34d, 34e) supported on an electrically insulating layer arranged on the outer wall surface 33 of the drum body. The electrodes are placed beneath a dielectric layer 35. An electronic control unit 43 having a drivers circuitry for energizing the electrodes individually is provided. The electronic control unit 43 is arranged on top of the outer wall surface 33 of the drum body 32 and is covered by the electrically insulating layer which supports the electrodes.

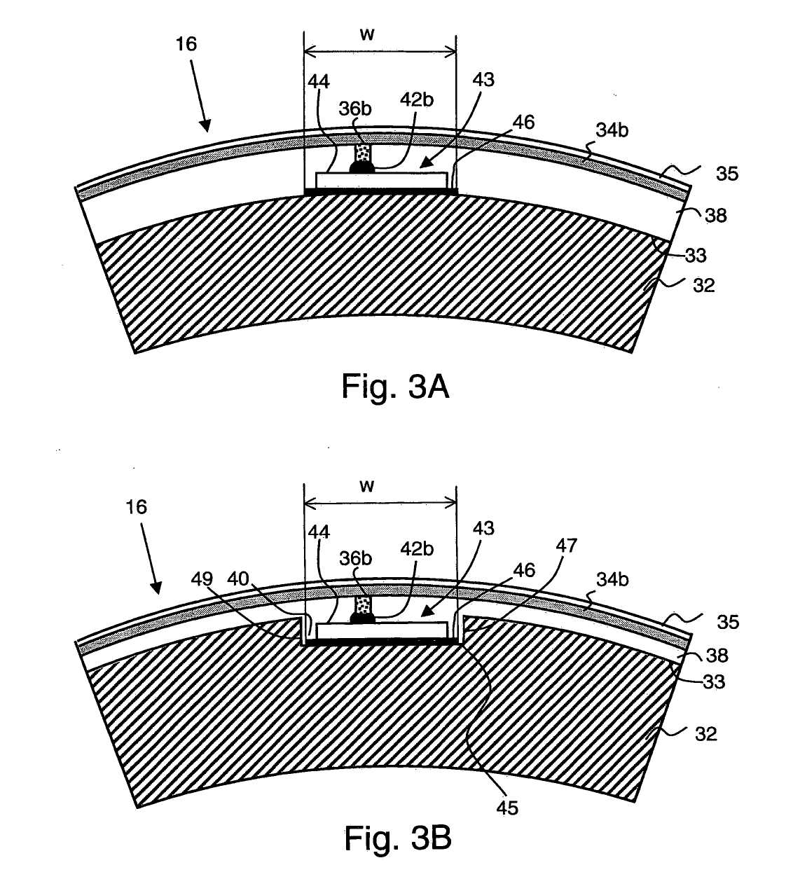

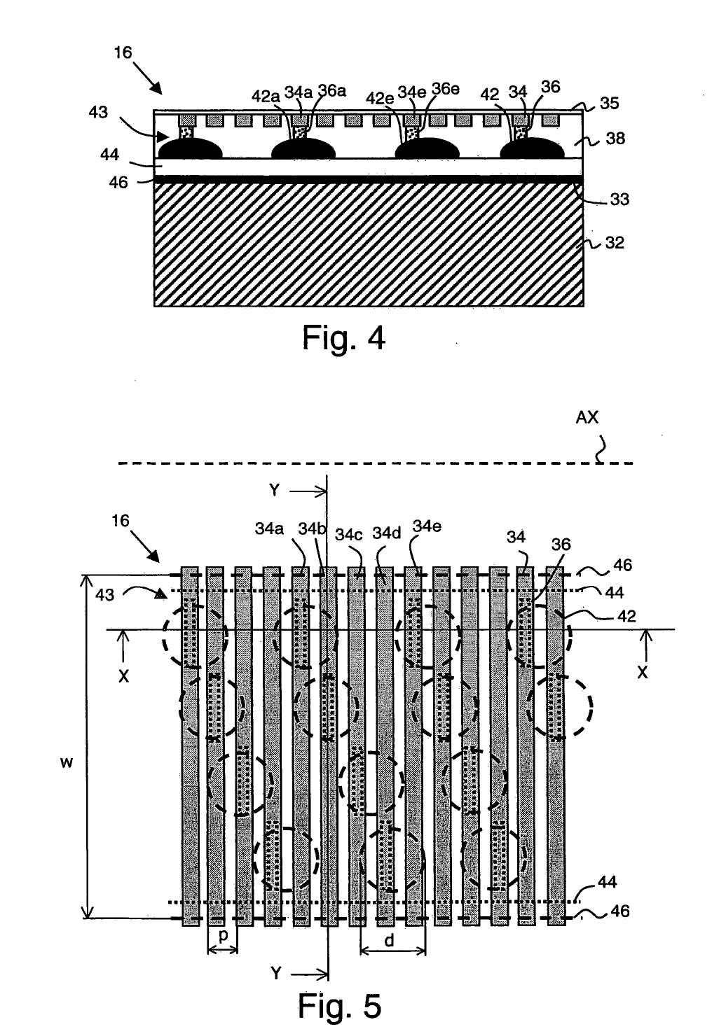

FIG. 5 represents schematically a top view of an embodiment of the image-forming element 16 according to the invention. FIG. 4 represents a cross section of the image-forming element along a line XX. FIG. 3A represents a cross section of a first embodiment of the image-forming element 16 taken along a line YY. FIG. 3B represents a cross section of a second embodiment of the image-forming element 16 taken along a line YY. The electrodes 34 are electrically insulated from the drum body by an electrically insulating layer 38, made for example of epoxy. The electronic control unit 43 comprises a drivers circuitry 44 for energising individually the electrodes, which are electrically insulated from one another. The drivers circuitry 44 is supported on a first side of a support structure 46. The support structure is for example a flexible board made out of a polyimide film, on which a pattern of electrical conductors is deposited for supplying the drivers circuitry with electrical signals. The use of a flexible board has the advantage of following closely the portion of the outer wall surface 33 on which it is brought up. In the embodiments of the image-forming element shown in FIGS. 3A, 3B, 4 and 5, a single support structure is shown, the length of which extends in a range substantially corresponding to the width L of hollow drum body. However, it is also possible to use a number of flexible boards each supporting a part of the drivers circuitry. In such as case, the connection between the diverse parts of the drivers circuitry can be achieved by wire bonds, but other well-known contacting means in the electronic packaging industry are also suitable.

Solder balls 42 and electrically conductive material 36 filling holes through the insulating layer 38 serve as contact means for electrically connecting each of the electrodes individually to the electronic control unit. Instead of solder balls, conductive epoxy pillars, copper pillars or electrically-conducting projections with a suitable shape can be used.

Each output of each driver of the drivers circuitry 44 is connected to a solder ball 42 deposited on the drivers circuitry. In order to obtain the desired solder balls pattern above the drivers circuitry, well-known structuring techniques are used, such as screen printing, photolithography in combination with electroplating or sputtering or the like. For a 600 dpi drum, wherein the pitch of the image-forming electrodes is 42.3 μm, the diameter of the solder balls is preferably chosen to be 120 μm. Generally, it is of great advantage that the diameter d of the solder balls (or of the conductive pillars or the like) is chosen to be at least two times the pitch p between the electrodes (see FIG. 5) in the axial direction AX. With solder balls or conductive pillars having such dimensions, the interconnections between said balls or pillars is easily achieved, even if some electrodes are not positioned exactly above their respective driver outputs. This is illustrated in FIG. 4 and FIG. 5, in particularly for the electrode 34e. There is thus no need for positioning the electrodes with respect to the electronic control unit with a high degree of precision.

Each electrode is electrically connected to the associated driver output via a through-hole which penetrates the insulating layer 38 and which is filled with an electrically conductive material 36 such as a metallic material, an electrically conductive epoxy resin, solder paste, electrically conductive polymer or the like. The trough-holes can be manufactured by laser drilling through the insulating layer 38. The through-holes are then filled with conductive materials to form contact means 36a, 36b, 36c, 36d for connecting, respectively, the electrodes 34a, 34b, 34c and 34d to the associated driver, each provided with a solder ball 42 for ensuring electrical contact.

FIG. 3A illustrates a first embodiment of the image-forming element according to the present invention. The electronic control unit is fixed on the outer wall surface 33 and the whole is covered by the electrically insulating layer 38.

FIG. 3B illustrates a second embodiment of the image-forming element according to the present invention. A recess 40 for accommodating the drivers circuitry 44 is formed in the outer wall surface 33 of the drum body. The recess has a bottom surface 45 extending in a direction substantially parallel to the axis of the drum body, in a range substantially corresponding to the width L of the drum 32. The recess 40 also has a first lateral wall 47 and a second lateral wall 49 extending essentially radially from the axis of the drum body, the first and second lateral walls having essentially the same height measured in a radial direction extending from the axis of the drum body. The height of the first and second lateral walls may be in the range 500 μm to 1000 μm. This shape of recess or groove is well-suited for accommodating an electronic control unit comprising a rectangular shaped single support structure for supporting the drivers circuitry. The thickness of the insulating electric layer 38, measured at the places of the outer wall surface 33 where no recess is present can be less than in the embodiment shown in FIG. 3A.

The drivers circuitry 44 is fixed in the recess 40, for example by gluing the second side of the support structure 46 onto the bottom surface 45 of the recess 40. Preferably, the adhesion between the support structure 46 and the bottom surface 45 is such that a good thermal contact is achieved between the electronic control unit with the drivers circuitry 44 and the drum body 32.

In use, the transfer drum 12 is heated and consequently, heat is transferred to all parts of the image-forming element 16. The temperature of the electronic control unit raises. With a good thermal contact between the electronic control unit and the drum body, heat can be evacuated by the drum body which is cooled by air flow circulating in its hollow. The drum body is preferably made out of a metallic material, such as aluminium, and is provided with heat sinks placed in its hollow. Since the hollow of the drum body is free of any electronic component, the shape of the heat sinks can be freely chosen. Their shape can be optimized for very efficient cooling. Compared to the known image-forming element, wherein the design of the heat sink had to take into account the presence of the electronic control unit, the image-forming element of the present invention is more reliable due to a more efficient cooling, and accordingly, high speed print processes are enabled. Compared to the image-forming element known from FIG. 9 of EP 0803 783 A1, wherein the hollow drum body is provided with a number of elongated openings, the image-forming element of the present invention is much more robust. Since there is no opening in the hollow drum body, it can support more external mechanical pressures with a reduced risk of damage. Moreover, compared to known arrangements, the image-forming element of the present invention offers advantages in terms of protection of the electronic control unit. Since the electronic control unit is on the outer wall surface of the drum body, covered by a layer of insulating material, there is less risk of damage due to accidental shocks. Moreover, the manufacturing of the known image-forming element is cumbersome, since the support structure carrying the drivers circuitry has to be secured in the elongated opening of the drum body with an insulating adhesive layer. With the image-forming element of the present invention, the support structure can be easily fixed on the outer wall of the drum body, which remains whole during manufacturing.

The volume of the recess not occupied by the electronic control unit can be filled with an electrically insulating material such as an epoxy resin. This material has the advantage that it can be chosen to have a suitable hardness in order to endure the forces exerted in use on the external surface the image-forming element.

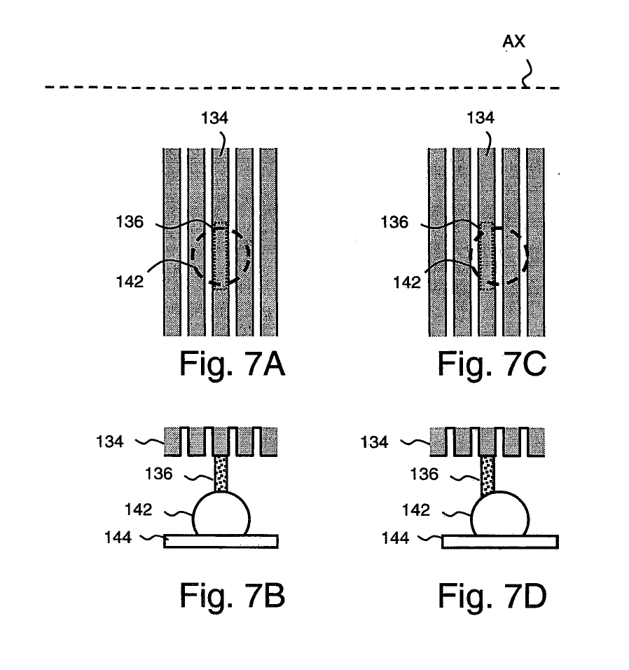

As shown in FIG. 5, the contact means 36 and the solder balls 42 may be staggered in four rows extending in the axial direction AX of the image-forming element 16. The pitch between the solder balls in a row is approximately equal to four times the pitch p between electrodes. For example, in an image-forming element achieving a 600 dpi print resolution (i.e. an electrodes pitch equal to 42.33 μm), the pitch between solder balls is approximately equal to 196.33 μm. The benefit of such a stagger arrangement is that the diameter of the solder balls may be larger than the electrodes pitch, for example twice or three times the electrodes pitch. It is thus possible to choose solder balls or conductive pillars having a diameter of the order of 120 μm, which increases the ease of manufacturing of the image-forming element, compared to solder balls or conductive pillars with a smaller diameter. This is explained in more detail hereunder and illustrated in FIGS. 7A, 7B, 7C, 7D.

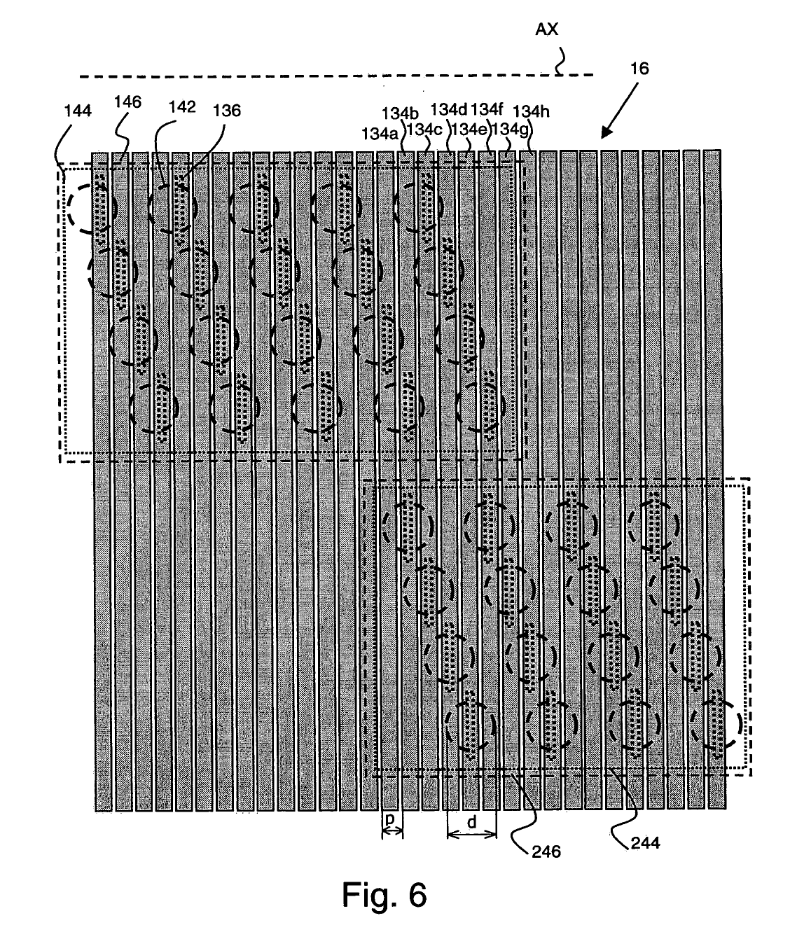

FIG. 6 is a schematic diagram of an image-forming element according to another embodiment of the present invention. The electronic control unit comprises a plurality of support structures for supporting the drivers circuitry. The first flexible board 146 is supporting a first part 144 of the drivers circuitry and the second flexible board 246 is supporting a second part 244 of the drivers circuitry. Although only two flexible boards are represented in FIG. 6, an ensemble of staggered boards is provided and arranged such that the ensemble of boards extend in the axial direction AX in a range corresponding approximately to the width L of the hollow drum 32. The connection between the diverse parts of the drivers circuitry may be achieved by wire bonds (not shown) such that an electronic control unit is obtained and such that signals can be provided to each individual driver for driving the associated electrode.

During manufacture, the solder balls or conductive pillars 142 can be positioned with a high degree of precision on ASICs (Application-Specific Integrated Circuit) 144, 244, making use of photolithography structuring techniques. The boards 146, 246 supporting the ASICs are then fixed on the outer wall surface 33. On a given ASIC, the pitch between solder balls is essentially constant and once the board with its ASIC is fixed on the outer wall surface 33 of the drum body, and the electrodes deposited, the shift between the array of solder balls and the array of electrodes is very small. As a consequence, there is always an electrode which is well positioned above a solder ball (or conductive pillar) provided that the diameter d thereof is chosen to be at least twice the electrode pitch p. After deposition of the insulating layer 38, the layer is structured in order to form small grooves wherein conductive material is to be deposited later to create the electrodes 134. After structuring of the insulating layer 38, through-holes are made through the layer 38 in order to form the interconnections 136 between the electrodes and the solder balls or conductive pillars 142. In FIG. 7A (top view) and FIG. 7B (cross section), the most favourable situation is illustrated. A groove for an electrode 134 is positioned almost exactly above the middle of the solder ball 142. The interconnection to the solder ball 142 is realized at the highest point thereof. In FIG. 7C and FIG. 7D, a somewhat less favorable situation is illustrated. There is no groove for an electrode lying almost exactly above the middle of a solder ball. However, the interconnection to the solder ball can be easily realized. In this case, the interconnection is not realized at the highest point of the solder ball. However, the electrical contact is obtained in a satisfying way. No special disposition has to be taken to position the boards supporting the ASICs on the outer wall surface in the axial direction AX of the hollow drum. A high degree of precision is not required, which is beneficial in terms of costs and ease of production. With a diameter of the solder balls of conductive pillars at least twice the pitch of the electrodes, connection to the electrodes is always possible. In the examples shown in FIG. 7A, 7B, 7C and 7D, the diameter d of the solder balls is chosen to be approximately three times the pitch p of the electrodes.

With the arrangement shown in FIG. 6, the manufacturing costs of an image-forming element are significantly reduced compared to the case where a single support structure is used. Due to practical manufacturing reasons, a single ASIC having a length approximately equal to the width L of the image-forming element is very difficult to produce with a good yield. It is much easier to manufacture ASICs having a smaller size, since a great number of small ASICs can be produced on a wafer. The production yield can thus be greatly enhanced compared to that of relatively long single ASICs. With the use of a number of small ASICs, however, the placement on the outer wall surface is more complicated than with a single structure. Experiences have shown that alignment of one ASIC with respect to another is then a critical point.

To solve this problem, the support structure 146 with ASIC 144, and the support structure 246 with ASIC 244 are placed in the axial direction AX of the hollow drum with an overlap. Placing the ASICs with such an overlap creates redundancy in the interconnections between the electrodes and the drivers. As a consequence thereof, a number of electrodes in the redundant areas are connected to two different drivers, each belonging to a different ASIC. This can be measured using appropriate circuits within the ASICs and corrected by tuning one of both drivers' outputs off. Electrodes 134b, 134c, 134d, 134e and 134f are each physically connected to two solder balls 142, each belonging to a different driver placed on a different ASIC, respectively ASIC 144 and ASIC 244. It is sufficient that the overlap is for one electrode only. With the arrangement of FIG. 6, the interconnection manufacturing process time can be greatly reduced. Per interconnection, the manufacturing time and the related costs are even independent of the print resolution.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An image-forming element which comprises;
a hollow drum body rotatably provided about an axis (AX) and having an outer wall surface,
a plurality of circumferentially extending electrodes supported on an electrically insulating layer disposed on the outer wall surface of the drum body,
an electronic control unit comprising a drivers circuitry for energizing the electrodes, a support structure for supporting the drivers circuitry, and contact means for electrically connecting each of the electrodes individually to the electronic control unit, wherein the electronic control unit is arranged on the outer wall surface of the drum body.

2. The image-forming element according to claim 1, wherein a recess is provided in the outer wall surface of the hallow drum body for accommodating the drivers circuitry said drivers circuitry being fixed in said recess.

3. The image-forming element according to claim 2, wherein the recess has a bottom surface extending in a direction substantially parallel to the axis (AX) of the drum body, and first and second lateral walls extending substantially radially from the axis (AX) of the drum body.

4. The image-forming element according to claim 2, wherein the volume of the recess not occupied by the electronic control unit is filled with an electrically insulating material.

5. The image-forming element according to claim 4, wherein the electrically insulating material is an epoxy resin.

6. The image-forming element according to claim 3, wherein a side of the support structure is fixed to the bottom surface of the recess.

7. The image-forming element according to claim 1, wherein the contact means comprises a number of electrically-conducting projections extending upwardly from the drivers circuitry and having a dimension (d) in a direction substantially parallel to the axis (AX) of the drum body which is at least twice the pitch (p) of the electrodes.

8. The image-forming element according to claim 7, wherein the contact means further includes electrically conductive material provided in holes extending through the insulating layer for contacting the electrodes with the electrically-conducting projections.

9. The image-forming element according to claim 1, wherein the support structure is flexible.

10. The image-forming element according to claim 9, wherein the flexible support structure is made of a polyimide.
